(19) United States
(12) Patent Application Publication
(10) Pub. No.: US 2004/0117958 A1
(43) Pub. Date: Jun. 24, 2004

(54) High temperature needle-felts with woven basalt scrims

(76) Inventor: Abraham Turkson, Woodridge, NY (US)

Correspondence Address: Steven J. Grossman, Grossman, Tucker, Perreault & Pfleger, PLLC, 55 South Commercial Street, Manchester, NH, 03101, US

(21) Appl. No.: 10/324,986

(22) Filed: Dec. 19, 2002

(51) Int. Cl. D04H 5/02

(52) U.S. Cl. 28/107; 442/402

(57) ABSTRACT

A textile composition having improved structural integrity, thermal stability, and chemical resistance. The textile composition includes a needle-felt material of a high temperature fiber combined with a woven basalt scrim material. The textile composition is preferably formed by needle-felting the high temperature fiber into a layer of woven basalt scrim.

### FIELD OF THE INVENTION

The present invention relates generally to needle-felted materials, and more particularly to needle felted materials incorporating high temperature fibers with woven basalt scrims.

### BACKGROUND OF THE INVENTION

Textile materials having relatively high services temperatures are used in a number of commercial and industrial applications. For example, fire resistant textiles have been used in thermal protection for firefighters and other emergency response workers in flammable environments. Other applications, such as filtering applications related to air pollution control in, for example, the asphalt, power, lime and carbon black industries, not only require resistance to high temperatures, but also a resistance to harsh chemical environments. Numerous fibers are known that have a relatively high service temperature, and, in some cases, also exhibit good resistance to chemical attack. Exemplary fibers include aramid fiber, polytetrafluoroethylene fiber, carbon fiber, etc.

Basalt has long been known as a hard, dense, volcanic rock material, composed primarily of plagioclase, pyroxene and olivine, with a glassy appearance. Accordingly, commercial applications of cast basalt have been well known for a long time. However, only more recently was it learned that basalt can be formed into a continuous fiber having unique mechanical, thermal and chemical properties. For example, melting temperature above 1300° C., working temperatures of up to 1000° C., extreme hardness, 6.5 Moh's (Diamond=10), low thermal conductivity, high chemical resistance, and excellent economics to other high temperature resistant fiber alternatives.

Not surprisingly, given the more recent availability of basalt in fiber forms, efforts have surfaced seeking to identify novel applications of basalt fiber for commercial use. For example, as noted in U.S. patent application Ser. No. 2002/004127A1, a fire resistant material is disclosed which includes a matrix of basalt mineral fibers and glass fibers distributed throughout a fire resistant panel. The relative size of the basalt fibers and glass fibers are identified as critical, in the sense that the glass fibers are said to be smaller than the basalt fibers and are interspersed between the basalt fibers in the matrix. The subject matrix is described as being preferably in a rigid form, such as a panel or board. In addition, the average length of the glass fibers is said to be preferably between 0.1-10 mm, and the glass fibers is described as having a softening point below the crystallization point or sintering point of the basalt fiber component. In addition, the basalt fibers are said to preferably have an average thickness of 0.1 μm-100 μm, and is present at a range of 10-90% w/w of the panel.

Attention is also directed to U.S. patent application Ser. No. 2001/0053645 which is directed at a ballistic resistant article including at least one layer of fibrous armor. Each fibrous layer includes two or more layers of fibrous ply, each having a plurality of unidirectional oriented fiber. A hard armor layer may be bonded to the fibrous armor layer, and the hard armor layer may comprise metal or a thermoplastic or thermoset resin reinforced with aramid, ceramic, carbon and/or basalt fiber material.

U.S. Pat. No. 5,295,221 entitled “Papermaking Fabric” discloses a papermaking fabric for use as a press felt and which comprises basalt fibers. More specifically, the paper making fabric is said to comprise, in combination, any one or more of the following: (i) a fibrous batt, comprising a nonwoven layer including at least a proportion of basalt fibers; (ii) a base structure in the form of a mesh or grid formed by perforation in a sheet of resin bonded and/or mechanically consolidated nonwoven fibers, at least a proportion of which are basalt fibers; and (iii) a layer comprising core yarns or fibers wrapped with basalt fibers. In addition, with respect to the fibrous batt, it is said that this may be specifically supported on a nonwoven resin impregnated support fabric, and the fibrous batt may consist of a nonwoven layer of a blend of fibers including basalt fibers or micro-fibers, and natural or synthetic fibers. The latter are said to possibly comprise one or more of nylon, polyester, polyolefin, polyketone, polyphenylene oxide, polyphenylene sulfide, a fluropolymer or PEEK.

Attention is next directed to U.S. Pat. No. 5,671,518 entitled “Methods For Producing A Mineral Wool Needle-Felt And A Mineral Wool Product Using A Thixotropic Additive”. This particular disclosure, among other things, identifies a method of producing a mineral wool product with fibers positioned at an acute angle to a main face by the steps of producing fibers in a fiberizing device, providing a binder, depositing the fibers in the form of a laminar mat, providing a processing aid (thixotropic additive) and crimping the laminar mat by introducing forces parallel to a surface of the mat in the direction of movement of the mat before the binder hardens.

Finally, attention is also directed to U.S. Pat. Nos. 6,156,682; 6,358,591 and 6,468,930 which deal with laminated fibrous structures, insulation blankets containing fire blocking materials and cardable blends of dual glass fibers.

Accordingly, it is an object of this invention to identify and manufacture, in an efficient a manner as possible, novel needle felts incorporating woven basalt scrims, in combination with selected staple fibers, to provide an improved needlefelt material with, among other things, improved thermal stability.

More specifically, it is an object of the present invention to needle punch heat resistant fibers into woven basalt fabric (uniquely serving as a scrim component) in order to provide a high temperature textile composition and to improve upon the established performance of the selected heat resistant fiber, via adjustment of the concentration, distribution and type heat resistant fiber within the final needle felt product.

### SUMMARY OF THE INVENTION

In a first embodiment, the present invention is directed at a high temperature textile composition comprising non-woven high temperature fibers combined with a woven basalt scrim substrate. In method form, the present invention is directed at a method of making a high temperature textile composition comprising providing a woven basalt scrim material, providing non-woven high temperature fibers on at least a first side of the basalt scrim material, and needle punching the non-woven, high temperature fibers into the woven basalt scrim material.

### DETAILED DESCRIPTION OF THE PREFERRED EMBODIMENTS

As noted above, a first embodiment of the present invention is directed at a high temperature textile composition including a high temperature fiber integrated with a woven basalt scrim material. Desirably the high temperature fibers are integrated with the basalt scrim material by needle punching the fibers into or through the woven basalt scrim material. The resultant structure is a needle-felt of high temperature fibers including a woven basalt scrim. The textile structure provides improved structural integrity, thermal stability, and chemical resistance over a needle-felt which relies only upon the high temperature fiber, or combination of high temperature fibers.

In addition as noted, the present invention further relates to a method of producing a high temperature textile composition including high temperature fiber combined with a woven basalt scrim material. The method includes providing a basalt scrim material having a woven structure. High temperature fiber is provided to at least one side of the basalt scrim material. The high temperature fiber is then needle punched into and/or through the woven basalt scrim, producing a needle-felt including the basalt scrim material as an integrated component. Optionally, and as more fully disclosed herein, the high temperature fiber may be needle punched on both sides of the woven basalt scrim.

A textile composition consistent with the present invention includes a needle-felt structure of high temperature fiber integrated with a woven basalt scrim material. As used herein, textile indicates a structure composed of individual fibers that are intermingled to form a generally continuous structure, and preferably, a homogenous distribution of fibers. Furthermore, as used herein high temperature fiber refers to a fiber that is capable of withstanding about 50 hours of continuous exposure to temperatures of about 300° F., with a loss of tensile strength of no more than about 5%.

In addition, in the broad context of the present invention, it has been found that preferably the amount of such high temperature fiber combined with the woven basalt scrim is about 10-90% by weight of the resultant fabric, including all 1.0% increments therebetween. In that sense, it can be appreciated that the present invention contemplates any range between and including 10-90% by weight of the resultant fabric, which percent variation can be readily adjusted to target the final performance characteristics of the high temperature fiber/woven basalt scrim composition.

The woven basalt scrim that is used in the present invention may be preferably obtained from Sudaglass Fiber, Houston, Tex. Such woven basalt is reportedly manufactured from yarns made from continuous filament basalt, to varying thickness, weight, weave pattern, etc. They are available at 160 g/m² to 850 g/m².

The textile composition consistent with the present invention is preferably produced by needle punching the high temperature fiber together with the woven basalt scrim material. Needle punching, in general, locks fibers together forming a fabric structure, such as a felt structure. Needle punching uses a set, or several sets of barbed needles, which are mechanically moved up and down through a batt of carded staple fiber. As the needles moves through the batt, the barbs, located along the needle's length, capture individual staple fibers. Through mechanical needling action the fibers are intermingled with each other and simultaneously compacted. This process may be used to produce a uniform, compacted fabric, in which the fibers are packed against one another to minimized fiber pull out. The mechanical action of needle punching may be used to orient fibers in the X, Y, and Z-direction of the fabric. The Z-directional fibers may be used to lock several batts together to form fabric structures that are not possible with single carded batting.

According to the present invention, high temperature fibers are provided, for example, as a batt of fibers, to surface of a basalt scrim material. The high temperature fibers are integrated with the basalt scrim by needle punching through the high temperature fibers and into or through the basalt scrim material. The Z-directional fibers of the batt of high temperature fibers intrude into the basal scrim material and intermingle with the basalt scrim material. The intermingling of the high temperature fibers and the basalt scrim integrates or locks the felt of high temperature fiber, formed by the needle punching process, with the basalt scrim.

Consistent with an alternative and preferred embodiment, high temperature fiber may be provided to opposed sides of the woven basalt scrim, effectively sandwiching the scrim between two batts of high temperature fiber. Needle punching may then proceed from both sides. Consistent with this embodiment, a needle felt of high temperature fiber may be formed on, and integrated with both sides of the woven basalt scrim.

Consistent with the present invention, woven basalt scrim may be of any weight, generally determined by the end use requirements of the textile structure. However, desirably the scrim has a weight range of between about 1.5 to 16 oz/yd², and at any 0.1 oz/yd² therebetween. This weight range is considered particularly preferable for the reason that below 1.5 oz/yd² the scrim might not have the most efficient basalt mass to impart the most advantageous thermal stability, chemical stability, etc. By the same reasoning, when the basis weight of the woven basalt scrim exceeds 16 oz/yd² the additional and incremental contribution to thermal stability, chemical stability, etc. at such higher basis weights, while measurable and advantageous, becomes less preferred. Furthermore, it can be appreciated that these observations as to the desirable weight of the basalt scrim may also be influenced by the intended final weight of the textile structure.

Similarly, the construction of the woven basalt scrim is susceptible to numerous variations. Exemplary woven structures may include, for example, a plain weave, a satin weave, or a twill woven construction. In such regard, the aperture of the woven basalt scrim is also subject to variation. The woven basalt scrim material may be formed having a relatively open weave, providing larger apertures, or having a relatively tight weave, having a smaller aperture. The aperture size will, at least to some degree, determine the extent to which the needle-felt may be integrated with the woven scrim. This is believed to be the case since with a tighter weave fewer fibers will generally be needle punched into or through the entirety of the scrim.

Numerous fibers may be incorporated with the woven basalt scrim. However, fibers with lower temperature characteristics do not serve as the most efficient and preferred fibers for incorporation into the woven basalt of the present invention. Accordingly, the present invention is directed at high temperature fibers, that is, fibers that are thermally stable at temperatures above 300° F. By this it is meant that the high temperature fiber is a fiber which retains about 95% of its tensile strength after 50 hours of exposure at 300° F. This therefore may include a variety of appropriate thermoplastic and thermoset type fiber materials. However, particular preferred examples of suitable high temperature fibers include meta-aramids (Nomex™), para-aramids (Kevlar™), polyphenylene sulfide (Procon™ and Torcon™), polyimides (P84™), polytetrafluoroethylene (PTFE), fiberglass, and both partially and fully oxidized carbon fibers, and mixtures of such fibers.

According to one preferred embodiment consistent with the present invention, carbon fiber may be needle-felted and integrated with a woven basalt scrim. The carbon fibers may be fully carbonized fibers, such as those produced under the trade name Curlon™ by Orcon Corp. This integrated carbon fiber needle-felt and woven basalt scrim composition provides good structural integrity at continuous service temperatures of up to 700° F.

A second preferred exemplary embodiment consistent with the present invention includes the use of PTFE fibers. PTFE fibers needle-felted with a woven basalt scrim material provide a relatively cost effective material that is capable of operating under harsh chemical conditions, with surge temperature stability far higher than the continuous service temperature of 500° F. identified for PTFE fabrics. By surge temperature it is meant exposure at an indicated temperature for an indicated time (relatively short period of time, e.g., 5 minutes to 60 minutes) while retaining properties sufficient to continue in the given application.

According to another preferred exemplary embodiment, para-aramid fibers may be needle felted with a basalt scrim. As noted above, these are available under the tradename Nomex™. The resultant material exhibits enhanced thermal stability and chemical resistance and provides surge temperature stability far higher than the continuous service temperature of 400° F. identified for para-aramid fabrics

According to another preferred exemplary embodiment, polyimide fibers may be needle felted with a basalt scrim. As noted above, these are available under the tradename P84™. The resultant material exhibits enhanced thermal stability and chemical resistance and provides surge temperature stability far higher than the continuous service temperature of 500° F. identified for polyimide fabrics.

As a final preferred exemplary embodiment, the high temperature fiber may be a polyphenylene sulfide fiber. As noted above, these are available under the tradenames Torcon™ and Procon™. A needle felt of Torcon™ or Procon™ fiber integrating a woven basalt scrim layer also experiences improved chemical resistance, but is also able to provide surge temperature stability far higher than the continuous service temperature of 375° F. identified for PPS fabrics.

The actual effects of integrating a woven basalt scrim with a high temperature fiber are best illustrated by a comparative experiment measuring shrinkage at different elevated temperatures between a woven basalt scrim incorporating Nomex™ needle-felt, consistent with the present invention, and a 100% Nomex™ needle-felt not including a woven basalt scrim. Test specimens of each material were prepared having original dimensions of 6 inches by 6 inches, giving an initial area, Aₒ, of 36 square inches. The specimens of both the basalt scrim incorporating Nomex™ needle-felt and the 100% Nomex™ needle-felt were prepared from a material having a basis weight of approximately a 14 oz/yd². The weight percent of Nomex™ in this particular example was about 57%.

The specimens were heated for 60 minutes at test temperatures of 400, 450, 500, 550, and 600 degrees F. After heating at the test temperature for 60 minutes the area of each specimen, A₆₀, was measured. The percent shrinkage of each test specimen was calculated as the percent decrease in area using formula 1.

SHRINKAGE=[(Aₒ−A₆₀)/Aₒ]×100 (1)

The experiment was conducted for three series of specimens at each temperature. Table 1 reports the average shrinkage for each of the three experiments at each temperature. The results of the experiment reported in Table 1 indicate that while Nomex™ needle-felt with basalt scrim was unaffected by temperatures of up to 600 degrees F., 100% Nomex™ needle-felt experienced slight shrinkage even at 400 degrees F., and significantly greater shrinkage.

TABLE 1
Percent shrinkage at temperature

| Temperature, ° F. | Basalt/Nomex ™ | 100% Nomex ™ |
|---|---|---|
| 400 | 0 | 0.7 |
| 450 | 0 | 1.8 |
| 500 | 0 | 4.2 |
| 550 | 0 | 7.5 |
| 600 | 0 | 9.1 |

As can be seen from the above, employing woven basalt scrim with a needle-felted Nomex™ fiber provided considerable thermal stability to the textile, and in the broad context of the present invention, a unique textile composition has been developed.

It is to be understood that the embodiments that have been described herein are but some of the several which utilize this invention and are set forth here by way of illustration, but not of limitation. For example, the various features illustrated and described herein may be combined with other features illustrated and described herein. It is obvious that many other embodiments, which will be readily apparent to those skilled in the art may be made without departing materially from the spirit and scope of the invention as defined in the appended claims.

What is claimed is:

1. A high temperature textile composition comprising non-woven high temperature fibers combined with a woven basalt scrim substrate.

2. A high temperature textile composition according to claim 1 wherein the non-woven, high temperature fibers are incorporated with the woven basalt scrim substrate by needle-felting.

3. A high temperature textile composition according to claim 1 wherein the high temperature fibers comprise at least one of aramid fibers, polytetrafluoroethylene fibers, polyphenylene sulfide fibers, polyimide fibers, carbon fibers or mixtures thereof.

4. A high temperature textile composition according to claim 1 wherein the woven basalt scrim material has a plain, satin or twill construction.

5. A high temperature textile composition according to claim 1 wherein the woven basalt scrim material has a basis weight of between about 1.5-16 oz/yd².

6. A high temperature textile composition according to claim 1 wherein the high temperature fibers are present at a level of about 10-90 wt. % of the entire textile composition.

7. A high temperature textile composition according to claim 1 wherein the high temperature fibers are fibers which retain 95% of their tensile strength after 50 hours of exposure at 300° F.

8. A method of making a high temperature textile composition comprising:
providing a woven basalt scrim material having a first side and a second side;
providing non-woven, high temperature fibers on at least a first side of the basalt scrim material;
needle punching the non-woven, high temperature fibers into the first side of said woven basalt scrim material.

9. The method of claim 8 further including
providing non-woven, high temperature fibers on a second side of the basalt scrim material; and
needle punching the non-woven, high temperature fibers into the second side of the woven basalt scrim material.

10. A method of making a high temperature textile structure according to claim 8, wherein said high temperature fibers are fibers which retain 95% of their tensile strength after 50 hours of exposure at 300° F.

11. A method of making a high temperature textile structure according to claim 8, wherein providing non-woven, high temperature fibers comprises providing at least one of aramid fibers, polytetrafluoroethylene fibers, polyphenylene sulfide fibers, polyimide fibers, carbon fibers or mixtures thereof.
